(19) United States
(12) Patent Application Publication
(10) Pub. No.: US 2015/0002056 A1
(43) Pub. Date: Jan. 1, 2015

(54) VEHICLE, SYSTEM AND METHOD

(71) Applicant: General Electric Company, Schenectady, NY (US)

(72) Inventors: Henry Todd Young, Erie, PA (US); Bertrand Bastien, Munich (DE); Wolfgang Daum, Sussex, WI (US); Lembit Salasoo, Schenectady, NY (US); Ord Allen Randolph, III, Erie, PA (US); Timothy Gerard Richter, Wynantskill, NY (US); Robert Dean King, Schenectady, NY (US)

(21) Appl. No.: 14/459,412

(22) Filed: Aug. 14, 2014

Related U.S. Application Data
(62) Division of application No. 12/539,839, filed on Aug. 12, 2009.
(60) Provisional application No. 61/088,832, filed on Aug. 14, 2008.

(51) Int. Cl. H02P 3/14; H02P 4/00

(52) U.S. Cl. CPC H02P 3/14; H02P 4/00
USPC 318/376; 318/440

(57) ABSTRACT

A system includes a retarder in electrical communication through an electric link with an alternator, and a controller that compares a power measurement with an accessory load on a system during a retard event, and can reduce an electrical load on the alternator, or can remove all electrical loads from an engine, when electric power that is generated from the retarder is measured to be greater than an accessory load on the system. The system may include an alternator that provides a motor function to rotate a shaft coupled to an engine that is mechanically coupled to one or more mechanically drivable accessories. The alternator powers the mechanically drivable accessories in place of or in addition to the engine.

### CROSS REFERENCE TO RELATED APPLICATIONS

This patent application is a divisional of U.S. Non-Provisional patent application Ser. No. 12/539,839 filed on 12 Aug. 2009, which claims priority under 35 U.S.C. §119(e) from U.S. Provisional Application No. 61/088,832 filed on 14 Aug. 2008.

### TECHNICAL FIELD

The systems and techniques described herein include embodiments that relate to a vehicle and a control system for a vehicle. They further include embodiments that relate to a method of operating a vehicle.

### DISCUSSION OF RELATED ART

Open pit mines may use vehicles, such as haul trucks, to move material from one location to another around and within the mine. Some of these vehicles may use an diesel engine to drive a mechanical drivetrain in order to provide tractive torque to the wheels that drive the vehicle. Such mechanical drivetrains may include torque converters, transmissions, drive shafts and differentials to pass the torque from the engine to the wheels.

In an alternative to such mechanical trucks, other designs for vehicles drive the wheels via electric motors. In such an electrical truck, the diesel engine is connected to an electrical alternator or generator to generate electrical power which can be fed to electric motors to drive the wheels.

Because it may be desirable for these trucks to operate with a high fuel efficiency, there is a continued need to provide for improved systems for running and controlling such vehicles' operation.

### BRIEF DESCRIPTION

In accordance with one aspect of a system described herein, a system is provided having a retarder, a controller and an energy storage device. The retarder has a motor that can supply electric power through an electric link. The controller is capable of comparing a power measurement with an accessory load on a system during a retard event. The controller is also capable of reducing an electrical load on an alternator to about zero, or of reducing a mechanical load on an engine, when electric power generated from the retarder is measured to be greater than an accessory load on the system. The energy storage device is electrically coupled to the electric link and has a determined upper electrical load limit.

In accordance with another aspect of a system described herein, a system is proved having a power connector, an energy storage device and a traction motor. The power connector is configured to releasably contact an electrified trolley line or umbilical cable. The energy storage device is coupled to the power connector. The traction motor is capable of being powered by electricity that is supplied by the trolley line or the umbilical cable through the power connector, by the energy storage device, or both the power connector and the energy storage device.

In accordance with an aspect of a method described herein, a power measurement is compared with an accessory load on a vehicle system during a retard event. The electrical load on an alternator is reduced to about zero, or all electrical loads are removed from a diesel engine except for idle losses, when the power generated from the retarder is measured to be greater than an accessory load on the system.

In accordance with another aspect of a method described herein, a power connector is releasably contacted to an electrified trolley line. A traction motor is powered by electricity that is supplied by the trolley line through the power connector, by an energy storage device, or both the power connector and the energy storage device.

### BRIEF DESCRIPTION OF DRAWING FIGURES

The above mentioned and other features will now be described with reference to the associated Figures. In the Figures, like reference numbers are used to indicate the same or similar elements. These Figures are intended to illustrate, but not to limit the scope of the systems and techniques described.

FIG. 1 shows a schematic illustration of a system in accordance with an embodiment described herein.

FIG. 2 shows a schematic illustration of another system in accordance with an embodiment described herein.

FIG. 3 shows a schematic illustration of yet another system in accordance with the an embodiment described herein.

### DETAILED DESCRIPTION

In this description, reference will be made to a number of terms that have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

As noted above, vehicle 140 such as those used at mines, may generally include an engine or other power source, a system for conveying the engine's power to wheels or other motive components, and a control system for operating the vehicle. The engine or other power source may be referred to as the “prime mover” and is generally a device to convert fuel or some other form of stored energy into mechanical energy. The conveyance system may be a mechanical drivetrain, or an electrical system.

With reference to the vehicle, the vehicle can include a vehicle frame and chassis. Depending on the vehicle type, embodiments of the system can be suitably sized and configured for use in a particular application or end-use. Suitable applications may include an off-highway vehicle, an underground mining vehicle, a passenger vehicle, a marine vessel, or a locomotive. Each application may have constraints on the system design and operating parameters. For example, space or volume may be a factor in a passenger vehicle or locomotive application; whereas capacity or economic considerations may be a constraint on an off-highway vehicle or marine vessel.

In addition to these basic components, the vehicle may include other devices that require energy of some kind to operate. These devices may be related directly to the motion of the vehicle itself, such as devices to steer or decelerate the vehicle. Devices related to the intended purpose of the vehicle may also be included onboard, such devices for providing light or heat to a cabin, actuating a loading arm or scoop, or providing communications and control for the vehicle. Such devices are terms “accessories” herein, and the power that they collectively require is referred to as the “accessory load”. The power necessary for the accessory load will generally come from either the prime mover or a separate system provided specifically to power such devices.

In an exemplary vehicle, the prime mover may be connected to an alternator or electrical generator to turn at least a portion of the mechanical work performed by the prime mover into electrical power that can be used to drive some or all of the onboard devices. Electrical energy storage may be provided to capture unused electrical energy that is generated by the prime mover. This energy may then be used to power devices even when the prime mover is not operating.

In addition to the prime mover, other sources of energy may be used to power various onboard devices. Such sources may include separate power systems, such as auxiliary engines or batteries; environmental energy capture systems, such as photovoltaic systems; and devices designed to capture work done on the vehicle by sources other than the prime mover, for example as when it is braking.

For example, during decelerative braking a vehicle is losing kinetic energy, generally through a system that retards the motion of the wheels directly, and converts the lost kinetic energy into heat. For example, in a vehicle such as a mine truck with a mechanical drivetrain, a disc brake or other friction surface may be applied to slow the motion of the wheel or axle. Such friction produces heat, dissipating the kinetic energy of the vehicle into the environment. In an electrical vehicle, a further braking technique is available in which the electric motor driving the wheel or axle is used as a generator instead of a motor, thereby extracting energy from the wheels' motion, rather than driving the wheels' motion. This reverse operation creates electric energy, which can be routed to a resistor grid to be dissipated as heat.

In both systems, the work done on the vehicle to decelerate it (i.e., the lost kinetic energy) produces heat, which is dissipated to the environment and wasted as far as the vehicle is concerned. This heat loss may be exacerbated by factors such as devices designed to reduce the effect of the additional waste heat on the vehicle. For example, cooling systems such as fans may be required to enhance cooling. Such fans can be driven by a shaft, as a mechanical parasite off of the prime mover, or may be electrically driven. Both fan drives require continued energy input, whether mechanical or electrical.

In some vehicles, an energy storage device captures and stores at least part of the energy from braking. Energy storage device technologies may include batteries, flywheels, and capacitors, depending upon whether the energy captured is mechanical or electrical.

By using an appropriate combination of recapture and control, a more desirable vehicle configuration may provide one or more of the following characteristics: improved fuel efficiency, improved emissions, reduced noise, improved life, reduced cost, reduced failure rate, and improved productivity. It may be desirable to have a method of controlling a vehicles system that has characteristics or properties that differ from those that are currently available.

Embodiments of such systems may include systems that capture the energy from braking and distribute it appropriately within the vehicle. As discussed herein, the term “retarder” includes an electric motor capable of affecting a speed associated with an apparatus, such as a wheel or axle under braking. The retarder may further include components that receive electricity generated by the motor when functioning as a retarder. These optional retarder components can include one or more electrically resistive grids, power dissipation devices, power and/or energy storage devices, or electrical acceptance systems. The term “electromagnetic brake” may also be used interchangeably with “retarder” herein. A suitable retarder may include components that can be obtained commercially from such suppliers as FRENOS ELECTRICOS UNIDOS S.A. (FRENELSA) (Orcoyen, Navarra (España)); KLAM America Corporation, Inc. (Denver, Colo.); and Telma (Elk Grove Village, Ill.).

The retarder can be placed on an axle, transmission, or driveline and can include a rotor attached to the axle, transmission, or driveline and a stator attached to the vehicle chassis. The retarder can use electromagnetic induction to provide a retardation force, and the electric motor can generate electricity during that retard event. When a retard event occurs and braking is required, the electrical windings in the stator may be powered from an energy storage device to produce magnetic fields alternating in polarity for the rotor to move through. This induces eddy currents in the rotor and slows down the rotor, and hence the axle, transmission or driveshaft to which it is attached. The rotor may provide its own air-cooling, so no load is placed on the vehicle cooling system, and the operation of the cooling system may be quiet.

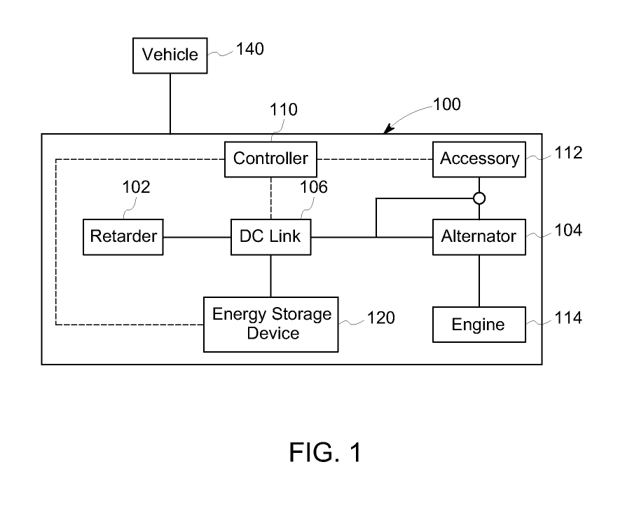

With reference to FIG. 1, a schematic illustration of an exemplary system 100 is shown. The system 100 is provided within the vehicle 140. The system 100 includes a retarder 102 in communication with an alternator 104 through a DC link 106. A controller 110 communicates with the retarder and the alternator as well as an accessory device or system 112. The alternator is mechanically coupled to an engine 114. The controller may also communicate with the DC link, optionally, to monitor loading, current and voltage, and with an energy storage device 120 that is electrically coupled to the DC link.

During operation, the system 100 can operate in several modes in which the controller monitors an electrical load of the accessory and the power available through the DC link. During one mode, such as a retard or braking event, the power available through the DC link is very high, and in this situation the available power is also higher than the electrical load or draw from the accessory. In this instance, the accessory is fully powered by the electricity available through the DC link, and the alternator supplies no power, and as such can be decoupled from the engine. The engine can be idled without parasitic loss, or can be shut down altogether. When the retard event ends, and the controller senses or predicts that the DC link supplied available power will be less then the accessory load, the controller can either draw power from the energy storage device or can initiate the engine to drive the alternator to supply power sufficient for the accessory load. If there is a delay in engine starting time, the controller may start to supply accessory power from the energy storage device, and then switch to alternator power once it becomes available.

A system 100 is provided that includes a retarder 102 and a controller 110 for the retarder. The controller compares a power measurement of the energy generated by the retarder at any given time with accessory load on the system. The controller can then reduce the required output from the alternator 104 (connected to the engine 114) when the power generated from the retarder is measured to be greater than the onboard accessory load demand. Alternatively or additionally, the controller can remove of all electrical loads from the engine except for idle losses.

That is, during braking when the retarder is generating electricity, the controller can use the electricity retarder instead of, or in addition to, the electricity generated by the alternator from the prime mover. Without an electrical load on the alternator, the engine does not need to spin the alternator. The engine can be disengaged from the alternator via clutch, or the engine can be shut down or set at reduced idle. The lower engine load can translate into one or more of lower fuel usage, lower emissions, and longer engine life. As noted in one embodiment, the engine shutdown and restart may be made more practical by leveraging the alternator as an engine starter. Further, in one embodiment, coupling an energy storage device into the system may allow for more frequent and/or longer engine shutdown periods, or longer engine idle cycles.

As noted above, the system may include an alternator 104. The alternator is coupled to a rotating shaft coupled to an engine 114, and can produce electrical power when the shaft is rotated. The engine may be mechanically coupled to one or more mechanically drivable accessories 112. The alternator can also be used to power the mechanically drivable accessories in place of mechanical energy supplied by the engine, if electrical power is supplied to the alternator. The mechanical output from the alternator when operated in this mode may be supplied to one or more components, such as the engine, a clutch assembly, or directly to an accessory.

If coupled to the engine, directly or through a clutch/gearing system, the alternator can rotate the crankshaft either wholly or supplemental to engine power. If coupled to the clutch assembly, the mechanical power can be diverted to, for example, a mechanically driven accessory (e.g., compressor, fluid pump and fan). The clutch may be disposed between the crankshaft and alternator shaft, with the mechanical accessory loads coupled to the alternator side of the clutch. Disengaging the clutch would allow the energy storage device or retarder power to drive the alternator to turn the accessories—without having to turn the engine crankshaft with the corresponding parasitic loss. During one operating mode, the engine may be powered down or stopped to reduce or eliminate fuel consumption and/or emissions of particular species. For example, by reducing the need to operate at idle simply to power accessory loads, comparatively higher NOx emissions associated with low-RPM operation may be avoided.

Alternatively, as briefly noted above, the alternator can power the mechanically drivable accessories in addition to the engine to supplement the engine power. This supplemental power approach may allow the engine to remain running in idle mode while supplying an amount of power to mechanically driven accessories that is in excess of the idle power. Suitable mechanically drivable accessories include one or more of an air conditioning compressor, a cooling fan, super charger, and hydraulic pump.

In one embodiment, the shaft is a crankshaft or a drive axle. Thus, using the alternator to rotate the crankshaft may propel the vehicle 140 with a mechanical transmission. The alternator may be used to ensure that the engine starts by supplementing or supplanting a starter. Particularly, in an OHV, passenger vehicle, or marine vessel, the alternator may differ from conventional alternators insofar as the instant alternator may have a separate or tapped winding. The alternator may have differing operating modes for motoring and for spinning the alternator, for example.

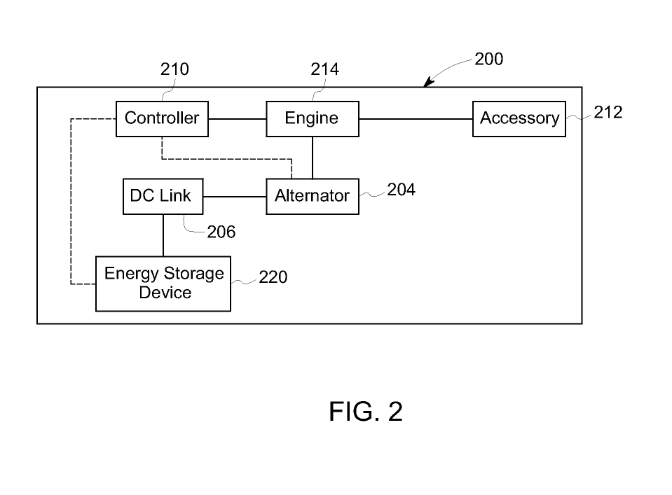

FIG. 2 illustrates a schematic diagram of a system 200 that includes an alternator 204 that is electrically coupled to a DC link 206, and communicates with a controller 210. An accessory 212 is mechanically driven by an engine 214. The controller also communicates with an energy storage device 220 that communicates with the controller and is electrically coupled to the DC link.

During use of the system 200, the alternator can draw on electrical power from the energy storage device to rotate the crankshaft (not shown) of the engine. The engine crankshaft can then mechanically power the accessory even with the engine in an idle mode or shut off. As the operating mode changes, the engine can power up or start, and can supply mechanical power to the accessory and to the alternator, which can then supply electrical power back to the DC link for powering electrical accessories (not shown) or to the energy storage device for storage.

A pre-start operating mode may use the alternator to spin up the crankshaft prior to and during an engine start event. That is, the alternator may replace a starter or cranking motor. Increasing the torque and speed of the crankshaft can be controlled to be prior to the injection fuel into the engine. The initial start may be then more smooth and have fewer hydrocarbon emissions (less unburnt fuel) then a corresponding start using a low RPM cranking motor or starter.

During various modes of operation, the alternator can accept mechanical energy from the engine while idling and supply electrical energy to the energy storage device. The energy storage device can supply power to the accessories or drive motors to supplement or replace crankshaft torque from the engine when not braking. For example, in one operating mode, the alternator can be spun to supply mechanical power to mechanically driven auxiliaries. The energy storage device can include an energy battery, a power battery, or both a power battery and an energy battery to define a multi-battery system. Alternatively, the energy storage device can include one or more flywheels, rechargeable fuel cell reactant banks, or capacitors. In one embodiment, a capacitor is part of, or coupled to, the energy storage device to reduce cycling on other components or to provide instantaneous power.

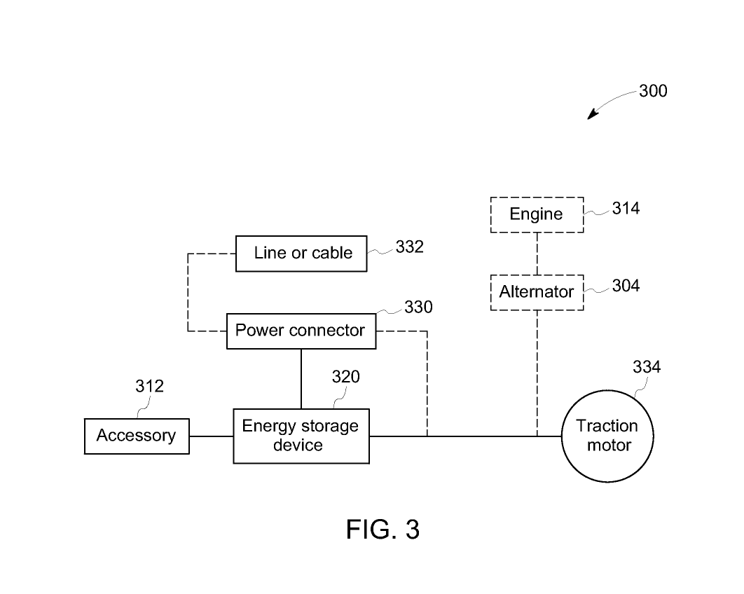

FIG. 3 is schematic illustration of a system 300 that includes an alternator 304 driven by an engine 314, an optional accessory 312 coupled to an energy storage device 320, and a power connector 330 coupled to the energy storage device and releasably connectable to an electrified trolley line or umbilical cable 332. Either the alternator or the energy storage device, depending on the operating mode, can power a traction motor 334. The traction motor optionally can be used for dynamic braking to generate electricity that is storable in the energy storage device. Power from the line transmits to the power connector, which then energizes the energy storage device. When the traction motor needs to provide motive power to a vehicle in which it resides, the energy storage device provides the power needed.

In alternative embodiments, indicated with dashed lines, the power connector can provide power directly to the traction motor, which can bypass the need for an inverter/rectifier/transformer. Or, the engine and alternator can be entirely absent, in which case the vehicle is an entirely electric vehicle that is powered by, for example, the energy storage device stored dynamic braking power, the trolley line, or a plug-in component (not shown) that connects to a grid, a stationary generator, or a portable electricity generator. Or, the engine can be present but undersized for high traction effort events (uphill haulage, large carry load, towing, and the like) so that in order to complete the high traction effort event, the combined power from the trolley line plus the energy storage device and/or the alternator can meet the power requirements.

In another aspect, a system includes a power connector that can releasably contact an electrified trolley line; an energy storage device coupled to the power connector; and a motor that is capable of being powered by electricity that is supplied by the trolley line through the power connector, by the energy storage device, or both the power connector and the energy storage device. The energy storage device powers the motor, and receives power from the power connector, from an on-board alternator, or from both the power connector and from the on-board engine. An off-board engine, such in a mother-mate configuration, can supply power through the power connector. The power connector can include a quick connect, quick disconnect coupler that allows for an electrical connection to be made by, for example, maneuvering a vehicle into a certain location or a certain orientation relative to a mating coupler. The mating coupler can be fixed, as in the case of a trailer that moves with a vehicle including the power connector. Alternatively or additionally, the mating coupler can be mobile relative to the power connector, such as in the case of a trolley line that slides against the power connector.

In one embodiment, the power connector powers the motor during an uphill haulage event or high tractive event. In one embodiment, the power connector powers the motor during an engine idle period during which an alternator is supplying little or no electrical output to the traction motor. In one embodiment, the power connector charges the energy storage device during an idle period during which an alternator is supplying little or no electrical output to the traction motor. That is, the vehicle can park under a trolley line, for instance, to charge up the energy storage device. Locating a trolley line near a queue of off-highway vehicles may allow the vehicles to charge during the wait for a loading shovel to be free. Alternatively, a trailer with an engine or an energy storage device may be connected to the vehicle right before the uphill haulage even or the high tractive power, the trailer can disconnect where convenient to either be fueled or recharged, and delivered downhill for the next trip. Alternatively or additionally, the energy storage device in the trailer may be recharged during the down hill journey from the retarding function of another vehicle to which it is electrically coupled during the downhill travel. Recharging may occur at a stationary power generation source. Suitable stationary sources may include gas-burning engines, bio-diesel engines, wind turbines, solar banks, hydro-generators, and the like.

The energy storage device can power a motor during a motor operation. In one embodiment, energy storage device can power the traction motor during a motoring event. For ease of illustration, the singular “motor” is used to indicate one or more motors, engines, prime movers, and fuel converters unless context or language indicates otherwise. The energy storage device either can complement the power supplied from another source, in one aspect; or, can be the sole source of power to the traction motor, in another aspect. In instances where the energy storage device is the only power source to the traction motor the system, such as a vehicle, can operate in a mode that has reduced noise, reduced emissions, reduced fire hazard, and reduced fuel and oxidant consumption. In an underground operating environment, the reduced fire hazard and reduced oxidant consumption may be controlled relative to the location of the vehicle in the underground environment, or can be controlled based on measurements of the environment itself. For stationary applications, the energy storage device only operating mode may be used during a power loss to a coupled grid system, or to supplement power in response to a high electrical load placed on the coupled grid. In these kind of underground operations, the onboard engine of the OHV can be shut down and the energy storage device or attached trailer can be used for propulsion, for retarding, and for auxiliary power.

In one embodiment, the motor can be supplied with power by the power connector, alone or in conjunction with the energy storage device, but not with the alternator. This operating mode may occur during an uphill haulage event or during a high tractive effort. The power connector can transfer power from the retarder to the trolley line. The trolley line and an energy storage device coupled to the trolley line, whereby the retarder generated power is capable of being stored by the energy storage device that is coupled to the trolley line. The power connector can charge the energy storage device during a period when the traction motor is not being powered and/or the vehicle is at rest.

Various electrical accessories can be coupled to the energy storage device. An auxiliary power unit (APU) can provide on-board power generation. The auxiliary power unit can charge the energy storage device, and can power one or more accessories, but is insufficient to provide tractive motor power. The auxiliary power unit can be used in an emergency situation to provide a limp home operating mode, or can be used in conjunction with the energy storage device, to provide short term power as needed. The limp home operating mode may provide full torque/tractive effort to haul the truck, however at full torque the vehicle may move at a lower speed.

Current (I) and voltage (V) sensors can provide measurements of current and voltage, respectively, of the energy storage device to the controller. The energy storage device can include a battery, and the battery can include a plurality of cells. The controller can calculate battery power (during discharging as well as charging) and battery state-of-charge (SOC). The battery's SOC is the percentage of the maximum charge capacity of the battery. Another controller input can be the polarity of the torque command from the controller to the motor. During the motoring event in the forward direction, the torque command is positive; and during the retard event where the traction motor or retarder is generating electricity, the torque command is negative. Battery power is the net ampere-hours removed from the energy storage device after being fully charged, including a correction factor based on battery temperature and battery age, if desired. The polarity of the battery power signal determines whether the battery is being discharged or charged; during normal usage the polarity is positive during discharging and negative during charging.

The battery power and SOC signals are inputs to the controller for providing a dynamic boosting or retarding of the heat engine power, and hence alternator power. The battery control loop controls the charging and discharging of the battery within its normal operating range by closed-loop control of the heat engine and alternator power levels for a given value of the motor power command. However, even as the battery voltage varies, the controller keeps alternator operation to be within determined current and voltage limits of the alternator. A battery voltage operating range may be, for example, in a range of from about 75% to 125% of the nominal voltage of the battery. In one electric drive system in accordance with an technique described herein, an electronic chopper may not be required to match the voltages of the battery, alternator and DC link.

During one motoring operation, the controller output can be responsive to one or more of the battery state of charge (SOC), the particular energy storage unit, and the operating parameters. The controller, in one embodiment, may respond such that as the SOC decreases, the power being supplied from the battery may approach its maximum discharge current (e.g., during acceleration, a high tractive event, or an uphill haulage event), and the controller provides output to initiate a dynamic boost of the energy storage device power, the auxiliary power, and/or the alternator power. At relatively low motor power, and when the battery SOC is above a predetermined threshold, no dynamic boost is required, and the engine runs at approximately the desired average power required to drive the vehicle. The battery and electric drive system can supply peak power (up to the power limit of the battery for the particular SOC). As motor power increases, the value of the heat engine command increases via the low pass filter and clamp to the value commanded by the driver of the vehicle as determined by the torque command and the motor speed signal, thereby minimizing emissions that would otherwise result from a fast transient in the heat engine operating point. In one embodiment, the motor speed signal may be directly measured using speed sensors; or, may be indirectly measured or inferred using other pieces of information like voltage, current, frequency, speed of other axles, speed from global positioning signals (GPS).

During regenerative braking or a retard event, the electric motor can operate as a generator, and regenerative braking power can be supplied to the battery. When the battery is able to accept recharge power (i.e., at relatively lower values of SOC), the controller can provide for higher levels voltage and/or current to the energy storage device before retarding the engine via a command. However, when the battery is more nearly fully charged, relatively low voltage or low current may flow to the energy storage device under influence of the controller before the controller signal retards the engine. Controlled regenerative braking in this manner can allow for control over battery life, relatively effective battery charging and energy capture, and engine use with regard to fuel consumption and emissions. As the level of regenerative braking power decreases, the controller can ramp a retard signal to zero and increase the engine power. This may reduce or eliminate spikes in determined species emissions that may otherwise result from a fast transient in the engine operating temperature and/or rate. In case of a capacitor, the SOC may be determined by V̂2, and in the case of a flywheel by speed̂2.

One or more engine maps may be derived from actual measurements of the engine operating at a steady-state power level up to the maximum available power for a given engine speed. Specifically, data measurements of engine emissions and fuel consumption for a range of engine power are collectively referred to as an engine map. From an engine map, operation characteristics for a given power command from the controller may be determined Operation characteristics may include one or more of fuel consumption rate, emission species generation rate, and arrival time (speed/distance). Additionally, from an engine map, the engine operating point (torque and speed) where the minimum emissions occur for a given power level may be derived and stored in, for example, look-up tables. The controller, then, may communicate or rely on an engine map to determine one or more operating parameters to control or affect performance or output from the system, or system components. Auxiliary load power, or any other load power, may be determined by direct torque/speed measurement or by voltage/current/freq measurement or from speed/load characteristics. Such characteristics may include one or more of temperature, pressure, speed for a fan load, inductive measurements, response of the load, and the like.

Electrically driven accessories may include one or more of cooling fan, air conditioning compressor, power steering, power brakes, an alternator, dc-dc converter, music system, communication equipment, navigation equipment, active suspension, hoist, and an air compressor.

In various embodiments, the retarder may be located in the vehicle chassis between a gearbox and a rear-driving axle if there is enough room between the axles. This placement may provide a high degree of braking ability. The retarder may be installed between a transmission and an axle and can be supported by one or more independent brackets. Alternatively, the retarder may be installed on the transmission with an adapter. Or, the retarder may be installed on a differential of the axle with an adapter. In one embodiment, the retarder is a traction motor that can propel the system.

A suitable controller includes those available from such controller suppliers as General Electric Company (Fairfield, Conn.) and Honeywell International, Inc. (Morristown, N.J.). In one embodiment, a Bachmann Programmable Logic Controller (PLC) can perform control, data acquisition, and HMI (human-machine interface) functions. Suitable engines may include a prime mover that is an MTU/Detroit Diesel series 4000 diesel engine (MTU/Detroit Diesel, Inc., Detroit, Mich.) rated 2500 hp at 1900 rpm. In one embodiment, an engine cooling system may include an L&M replaceable core radiator (L&M Radiator Inc., Hibbing, Minn.) and a Rockford Powertrain heavy-duty fan clutch (GKN Rockford, Inc., Loves Park, Ill.) may be controlled through an engine electronic control module. A Donaldson air cleaner system (Donaldson Company, Inc., Minneapolis, Minn.) may filter the air intake.

In one embodiment, a General Electric Statex III electric drive system that includes a directly driven General Electric GTA 26F alternator may directly connect to the engine. Alternatively, the alternator may be mechanically coupled directly to the engine, or alternatively may be coupled via gearing, a clutch, a belt, or a chain. For example, a General Electric 787FS motor with 31.875:1 planetary final drive can be coupled to each one of the rear wheels of a vehicle. The drive system in such a configuration can provide a maximum travel speed of more than 30 mph and 3770 horse power (hp) of standard dynamic retarding, with up to 4158 hp available. Other suitable AC drives and associated alternators include the General Electric GTA41, and AC traction motors may include the General Electric GEB16, 25, 26 along with appropriate microprocessor controllers.

The electric link can be an AC link or a DC link based on the system requirements. The DC link should be assumed unless context or language indicates the AC link is intended or possible. A suitable DC link can include positive/negative lines, and additional active or passive components can be added to the DC link as needed, such as a capacitor or a filter. The DC link can be coupled to the alternator. And, the DC link may be coupled to one or more insulated gate bipolar transistors (IGBT) and gate turn-off thyristors (GTO) if such are present. A Texas Instruments digital signal processor (DSP) can provide control to the DC/DC converter, particularly when multiple converters connect to a single DC link. While not referred to specifically, the DC power to and from the DC link may be converted to AC power to interface with, for example, the traction motor (as necessary) or the alternator, in an AC system. For a DC system, there may not be filters if the DC link is directly coupled to the motor. However, filters may be used if a chopper or if an energy storage device is used. The AC link can include a voltage, frequency and phase change device.

An energy storage device can be electrically coupled to the electric link. The coupling can be direct if the electric link is a DC link, or can be indirect if there is a voltage step change needed. Alternatively, the coupling can be through an AC/DC converter if the electric link is AC.

The energy storage device can include one or more separate storage components, and the components can be the same or different from each other in, for example, function or composition or type. Some examples may be illustrative. The energy storage device can include an energy battery plus a power battery; an energy or power battery plus a capacitor or quick capture/release device; or a flywheel plus a battery. The energy storage device can include a sodium metal halide battery, a sodium sulfur battery, a lithium-based battery, a nickel metal hydride battery, a nickel cadmium battery, or a lead acid battery, and these can be used alone or in combinations as appropriate based on the system needs. Each of these foregoing batteries may be included with other storage types, such as mechanical storage, chemical storage, pressure storage, or thermal storage. Mechanical storage can include flywheels or springs. Chemical storage can include fuel cell reactants (e.g., hydrogen, oxygen, etc.). Pressure and thermal storage are self-evident.

The energy storage device may have a determined upper electrical load limit. That is, the energy storage device may have one or both of a maximum voltage and maximum electrical current. Voltage or current sensors may monitor and/or report the voltage or current to which the energy storage device is subject to the controller. The controller may respond to the sensor signal. Other sensors may monitor and/or report the voltage or current to which an accessory electrical circuit is subjected. The accessory electrical circuit may have a measurable accessory load. The load may be dynamic and responsive to external or environmental factors.

Suitable controllers include microprocessors or microcontrollers, complex programmable logic devices, and field-programmable gate array devices, or an equivalent commercially available device. The controller may access a preset or determined combined electrical load that includes at least the electrical requirements for the existing accessory load on the accessory electrical circuit and the energy storage device electrical load. The controller can cause the routing of any electrical load that is in excess of the combined electrical load. The routing may be to, for example, a resistor bank during the retard event. The resistor bank may be part of the retarder system. A portion of the excess electrical load may discharge as thermal energy from the resistor bank. Suitable programmable logic controllers (PLC) are commercially obtainable from, for example, GE Fanuc (Charlottesville, Va.).

An AC/DC rectifier may be interposed between the DC link and the alternator in case of a DC link. In an alternate embodiment, an AC link is used, and the AC link may include a voltage changing device such as transformer. In another embodiment, the AC link may include a frequency or phase changing device such as an inverter. The AC voltage, frequency or phase changing devices may be employed by themselves or in a series or parallel combination with other AC or DC link combinations.

If present, an exciter can control the voltage produced by the alternator. The exciter can be a phase-controlled rectifier if the input to the exciter is AC. The exciter can be a DC/DC converter if the input is DC, and can be DC/AC if the alternator is a wound rotor machine.

The various embodiments described herein may be used to provide improved fuel efficiency in vehicles, such as mine-hauling trucks, as well as providing for improved noise levels and reduced wear on engines. Any given embodiment may provide one or more of the advantages recited, but need not provide all objects or advantages recited for any other embodiment. Those skilled in the art will recognize that the systems and techniques described herein may be embodied or carried out in a manner that achieves or optimizes one advantage or group of advantages as taught herein without necessarily achieving other objects or advantages as may be taught or suggested herein.

This written description may enable those of ordinary skill in the art to make and use embodiments having alternative elements that likewise correspond to the elements of the invention recited in the claims. The scope of the invention thus includes structures, systems and methods that do not differ from the literal language of the claims, and further includes other structures, systems and methods with insubstantial differences from the literal language of the claims. While only certain features and embodiments have been illustrated and described herein, many modifications and changes may occur to one of ordinary skill in the relevant art. Thus, it is intended that the scope of the invention disclosed should not be limited by the particular disclosed embodiments described above, but should be determined only by a fair reading of the claims that follow.

1. A system, comprising:
a power connector configured to releasably contact an electrified trolley line or umbilical cable;
an energy storage device coupled to the power connector; and
a traction motor configured to being powered by electricity that is supplied by the trolley line or umbilical cable through the power connector, by the energy storage device, or both the power connector and the energy storage device.

2. The system as defined in claim 1, wherein the traction motor is powered by the energy storage device and the energy storage device is configured to receive power from the power connector, from an on-board alternator, or from both the power connector and from the on-board engine.

3. The system as defined in claim 1, wherein the power connector powers the traction motor during an uphill haulage event or high tractive event.

4. The system as defined in claim 1, wherein the power connector powers the traction motor during an idle period during which an alternator is supplying little or no electrical output to the traction motor.

5. The system as defined in claim 1, wherein the power connector charges the energy storage device during an idle period during which an alternator is supplying little or no electrical output to the traction motor.

6. The system as defined in claim 1, wherein the traction motor is being powered by the energy storage device, and the energy storage device is being charged by the power connector during a period when the traction motor is not being powered and/or the vehicle is at rest.

7. The system as defined in claim 1, wherein the traction motor is being supplied with power by one or both of the power connector and the energy storage device, but not the alternator, during an uphill haulage event or a high tractive effort.

8. The system as defined in claim 1, wherein the power connector is further configured for transferring power from regenerative braking unit to the trolley line during regenarative braking event.

9. The system as defined in claim 8, further comprising the trolley line and an energy storage device coupled to the trolley line, whereby the a regenerative braking unit generated power is being stored by the energy storage device that is coupled to the trolley line.

10. The system as defined in claim 1, further comprising an auxiliary power unit (APU) configured for providing on-board power generation.

11. A method, comprising:
releasably contacting a power connector to an electrified trolley line; and
powering a traction motor by electricity that is supplied by the trolley line through the power connector, by an energy storage device, or both the power connector and the energy storage device.

12. The method as defined in claim 11, further comprising controlling the traction motor power to affect an operating mode of a vehicle.

13. The method as defined in claim 11, further comprising reducing engine on time by idling or shutting down the engine while the traction motor is powered by the electricity supplied by the trolley line, the energy storage device, or both the trolley line and the energy storage device.

14. The system as defined in claim 2, wherein the alternator accepts mechanical energy from the engine during an idle event and supplies electrical energy to the energy storage device.

15. The system as defined in claim 14, wherein the alternator is directly mechanically coupled to a prime mover.

16. The system as defined in claim 9, wherein the regenerative braking unit comprises a resistor bank configured to discharge at least a portion of an excess electrical load as thermal energy.

17. The system as defined in claim 1, further comprising a vehicle frame and chassis, and wherein the system is suitably sized and configured for use in an off-highway vehicle, an underground mining vehicle, a passenger vehicle, a marine vessel, or a locomotive.

18. The method of claim 12, wherein the operating mode comprises at least one of a fuel consumption rate, an emission species generation rate, and an arrival time of a vehicle.
